(19) United States
(12) Patent Application Publication
(10) Pub. No.: US 2007/0177397 A1
(43) Pub. Date: Aug. 2, 2007

(54) Lighting apparatus for vehicle

(75) Inventors: Yasuhiro Sakakibara, Aichi-ken (JP); Naoki Omatsu, Aichi-ken (JP); Kohki Ishikawa, Tokyo (JP); Mitsuru Kamikatano, Sakura-shi (JP)

Correspondence Address: POSZ LAW GROUP, PLC, 12040 SOUTH LAKES DRIVE, SUITE 101, RESTON, VA, 20191, US

(73) Assignees: TOYODA GOSEI CO., LTD., Aichi-Ken (JP); FUJIKURA LTD., Tokyo (JP)

(21) Appl. No.: 11/657,714

(22) Filed: Jan. 25, 2007

(30) Foreign Application Priority Data
Jan. 27, 2006 (JP) 2006-19690

(51) Int. Cl. B60Q 1/26; B60Q 1/00

(52) U.S. Cl. 362/488; 362/326

(57) ABSTRACT

The invention provides a lighting apparatus which can reduce a layout space within a vehicle and can easily arrange a wiring. A translucent portion of a board lighting apparatus and a translucent portion of a console lighting apparatus are structured such as to serve as a decorative luminous portion and a lighting luminous portion. Since the board lighting apparatus is arranged in an upper side of a glove compartment, it is possible to apply decoration to a portion around the glove compartment and light a space at a time when the glove compartment is open. Since the console lighting apparatus is arranged in an upper side of the center console, it is possible to apply decoration to a portion around the center console and light an area around the feed of a passenger.

### BACKGROUND OF THE INVENTION

The present invention relates to a lighting apparatus for a vehicle having a luminous portion irradiating light generated by a luminous body into a passenger compartment.

Conventionally, in a compartment of a vehicle, a lighting apparatus aiming at indoor lighting or decoration is attached to the inside of the compartment. As such a lighting apparatus, there is a structure which assists getting on and off by illuminating the area around the feet at a time when a user gets on and off the vehicle (for example, Japanese Laid-Open Patent Publication No. 2005-1612). In the lighting apparatus described in this publication, the lighting apparatus and a cover portion are integrally attached to a bottom surface of a side mirror. Further, the lighting apparatus mentioned above is structured such that a plurality of LED lamps are mounted, and the area around the feet of the user is illuminated over a wide range. Further, in the case that a vehicle door is unlocked by a keyless entry system provided in the vehicle at a time when an engine of the vehicle stops, the lighting apparatus is turned on so as to illuminate the area around the feet of the user at a time of getting on.

However, the lighting apparatus mentioned above is turned off after continuing the lighting for a predetermined time. Since the lighting of the lighting apparatus is completed after a short time, it is impossible to use the lighting apparatus as lighting for decoration aiming at improving the decoration of the vehicle. Accordingly, in the case that the lighting is used for improving the decoration of the vehicle, it is necessary to newly set a lighting apparatus for decoration in addition to the lighting apparatus. In this case, it is necessary to create an installation space for the lighting apparatus for decoration, and it is necessary to wire a harness for the lighting apparatus. Further, the harness is entwined at a degree of wiring the harness for the lighting apparatus for decoration, and the harnesses come into collision with each other within the passenger compartment, whereby there is a risk that an abnormal noise is generated.

### SUMMARY OF THE INVENTION

An objective of the present invention is to provide a lighting apparatus for a vehicle which reduces a layout space of the lighting apparatus within a vehicle, and facilitates arrangement of wiring.

In order to achieve the objective mentioned above and in accordance with one aspect of the present invention, there is provided a lighting apparatus for a vehicle having a luminous portion irradiating light generated by a luminous body into a passenger compartment. The luminous portion of the lighting apparatus is structured by integrally forming a decorative luminous portion for applying decorative light having a decorative effect to the passenger compartment, and a lighting luminous portion generating illuminating light having an illuminating effect for lighting a predetermined position within the passenger compartment.

### BRIEF DESCRIPTION OF THE SEVERAL VIEWS OF THE DRAWINGS

FIG. 1 is a perspective view showing the interior of a passenger compartment;

FIG. 2 is an enlarged view around a glove compartment;

FIG. 3A is a schematic view showing a decoration member, FIG. 3B is a cross-sectional view taken along line 3B-3B in FIG. 3A, FIG. 3C is a cross-sectional view taken along line 3C-3C in FIG. 3A, and FIG. 3D is a partially enlarged view of FIG. 3B;

FIG. 4 is a perspective view showing a lighting member; and

FIG. 5A is a schematic view showing a decoration member, FIG. 5B is a cross-sectional view taken along line 5B-5B in FIG. 5A, FIG. 5C is a cross-sectional view taken along line 5C-5C in FIG. 5A, and FIG. 5D is a partially enlarged view of FIG. 5B.

### DETAILED DESCRIPTION OF THE PREFERRED EMBODIMENTS

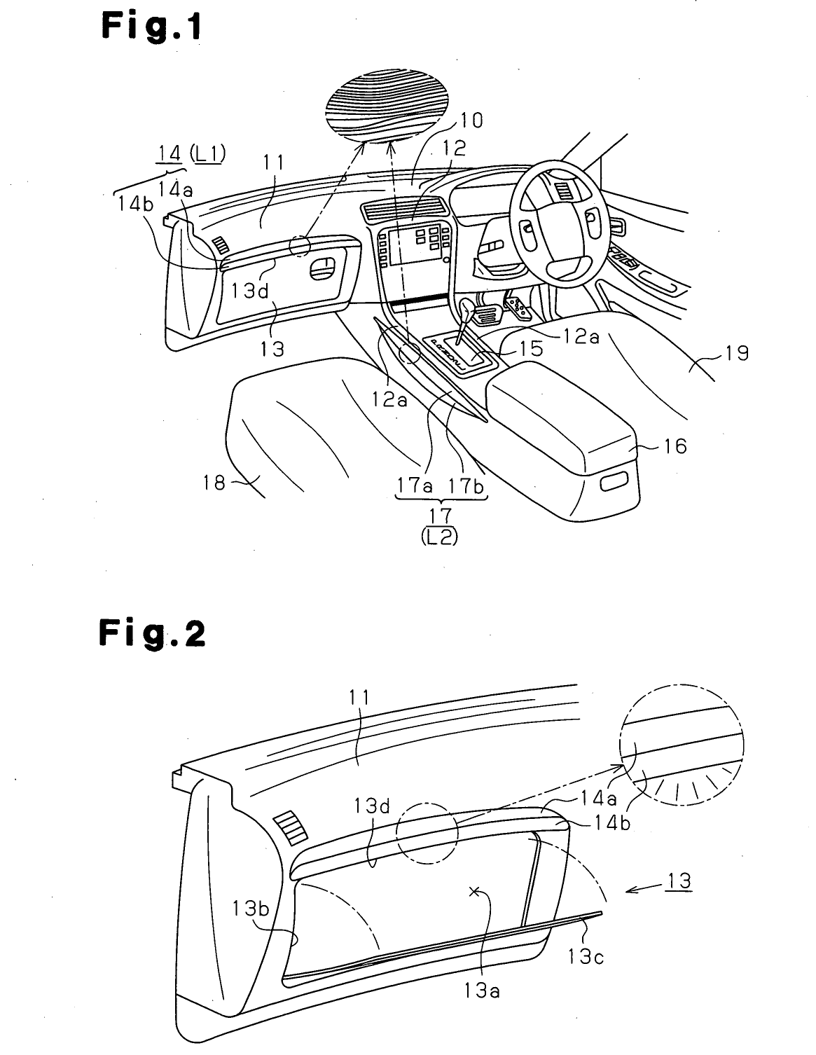

A description will be given below of a lighting apparatus for a vehicle according to one embodiment of the present invention with reference to FIGS. 1 to 5.

As shown in FIG. 1, an instrument panel 10 is arranged within a passenger compartment along a vehicle width. A dashboard 11 is provided in the instrument panel 10 so as to be positioned in a front surface of a front passenger seat. A center console 12 is provided between a driver seat and the front passenger seat, in a center of the vehicle. A glove compartment 13 is arranged below the dashboard 11. The glove compartment 13 is provided with a space 13a for storing articles, and an opening and closing door 13c opening and closing a storage port 13b of the space 13a, as shown in FIG. 2. A shift device 15 is arranged in the center console 12, and a console box 16 is arranged in a rear side of the shift device 15. A seat base 18 for a front passenger seat and a seat base 19 for a driver seat are arranged at both sides of the center console 12.

Further, a board lighting apparatus L1 is arranged in an upper edge 13d of the glove compartment 13. Further, a console lighting apparatus L2 is arranged in an upper edge 12a in each side surface of the center console 12. The console lighting apparatuses L2 are extended to the console box 16 through side surfaces of the shift device 15. The console lighting apparatuses L2 are symmetrically provided in both of the front passenger seat side and the driver seat side around the center console 12, and FIG. 1 only shows the console lighting apparatus L2 in the front passenger seat side.

The board lighting apparatus L1 is molded from transparent acrylic resin, and is constituted by a decoration member 14 capable of generating light, and a lighting member 20 irradiating the light to an inner portion of the decoration member 14. The console lighting apparatus L2 is molded from transparent acrylic resin, and is constituted by a decoration member 17 capable of generating light, and the lighting member 20 irradiating the light to an inner portion of the decoration member 17.

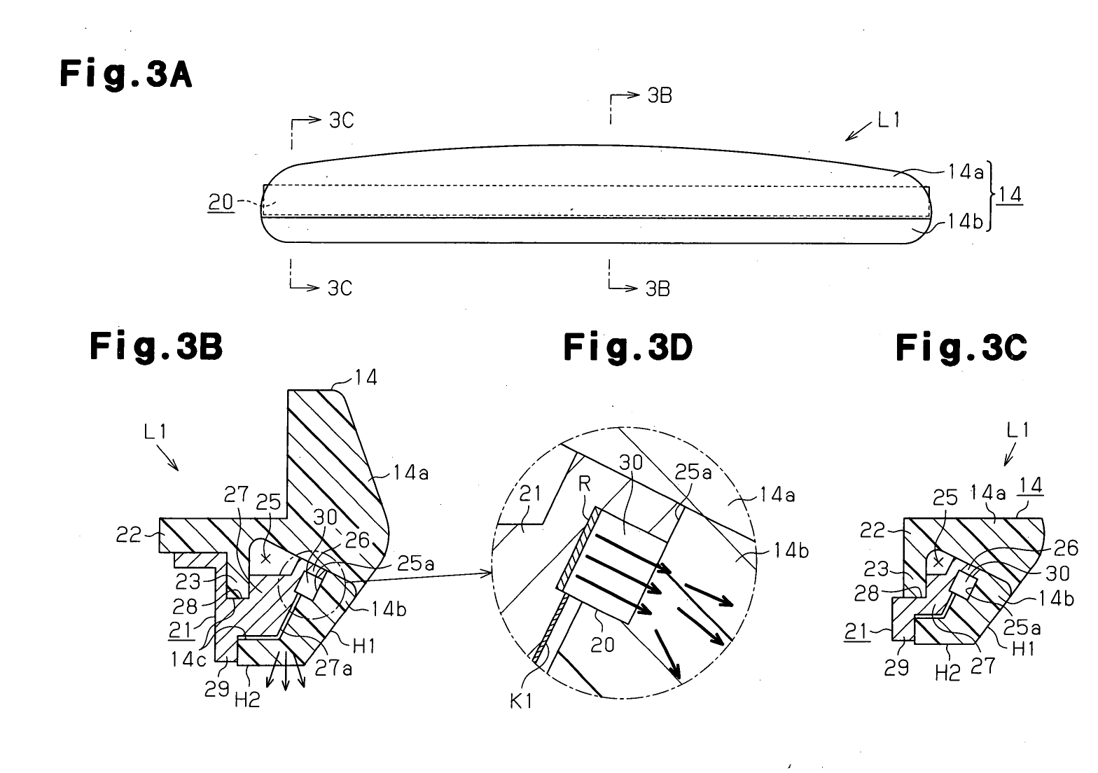

A description will be given below of a specific structure of the board lighting apparatus L1 and the console lighting apparatus L2 with reference to FIGS. 3 to 5.

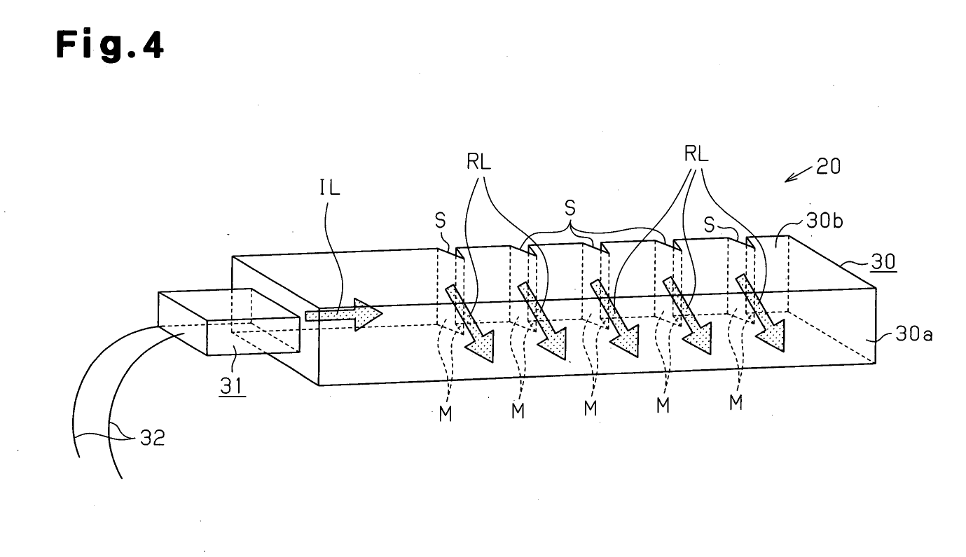

A description will be first given of the structure of the board lightning apparatus L1 with reference to FIGS. 3 and 4.

As shown in FIGS. 3A, 3B and 3C, the decoration member 14 constructing the board lighting apparatus L1 is molded in a rectangular shape in such a manner as to be rounded in four corners. Further, a protrusion portion protruding toward a passenger is formed in a center of the decoration member 14. A surface of the decoration member 14 is inclined toward an outer edge of the decoration member 14 from the protrusion portion. The decoration member 14 is inclined to a lower side of the decoration member 14 from the protrusion portion, in a left end portion of the decoration member 14, as shown in FIG. 3C.

The decoration member 14 is constituted, for example, by an upper side decoration portion 14a to which a woodgrain pattern is applied, and a lower side translucent portion 14b to which no pattern is applied, and which serves as a luminous portion transmitting light, and the decoration portion 14a and the translucent portion 14b are integrally molded. The pattern is applied to the decoration portion 14a in accordance with an in-mold process, a hydraulic pressure transfer process or the like. The pattern is applied to the decoration portion 14a in such a manner as to prevent the light from transmitting.

A positioning portion 22 for positioning at a time of arranging the decoration member 14 within the passenger compartment is formed in a back surface of the decoration portion 14a so as to protrude, and a protrusion portion 23 protruding to a lower side from the positioning portion 22 is formed. Further, the translucent portion 14b is formed in a lower side of the protrusion portion of the decoration member 14. The translucent portion 14b has an inclined surface H1 inclined forward in such a manner as to form an inclined surface of the decoration member 14, and a horizontal surface H2 connected to the inclined surface H1.

The light is irradiated into the passenger compartment via the inclined surface H1 and the horizontal surface H2 of the decoration member 14. Further, the light transmitting through the inclined surface H1 in the translucent portion 14b is irradiated to the decoration member 14 toward a diagonally forward portion as shown in FIG. 3B, and the light transmitting through the horizontal surface H2 is irradiated toward the lower side of the decoration member 14, as shown in FIG. 3B.

Further, an accommodation space 25 having an opening portion 14c is defined in the decoration member 14 by an inner surface of the decoration portion 14a including the protrusion portion 23 and an inner surface of the translucent portion 14b. The accommodation space 25 is formed over between both right and left end portions of the decoration member 14. A lighting member 20 for irradiating light is accommodated in the accommodation space 25, and a support device 21 serving as a support member for supporting the lighting member 20 is accommodated in the accommodation space 25.

The support device 21 is made of a resin, and is provided with a support device main body 27 having a surface 27a brought into contact with a back surface of the translucent portion 14b. A hook-shaped support portion 26 supporting the lighting member 20 (a light guiding body 30) within the accommodation space 25 is formed in the support device main body 27. Further, in the support device main body 27, there are formed a notch portion 28 formed by notching the support device main body 27, and an extension portion 29 extending to a lower side of the notch portion 28. A decoration having a metallic lustrous shining is applied to a position corresponding to a surface 27a of the support device main body 27 and facing the inner surface of the translucent portion 14b in a state of accommodating the support device 21 in the accommodation space 25. In the following description, as shown in FIG. 3D, the surface 27a of the support device main body 27 to which the decoration is applied is referred to as a decorative surface K1. The support device 21 has the same length as that of the accommodation space 25 of the decoration member 14, and is arranged over between both right and left end portions of the decoration member 14.

As shown in FIG. 4, the lighting member, that is, the luminous body 20 is provided with the light guiding body 30 formed in a rectangular parallelepiped shape by a resin and having a translucency. The light guiding body 30 has a front surface 30a and a rear surface 30b which are parallel to each other. A plurality of (five in the present embodiment) slits S extending up and down of the light guiding body 30 are formed in the rear surface 30b of the light guiding body 30. A plurality of slits S are formed at a predetermined interval along a longitudinal direction of the light guiding body 30. Each of the slits S has a V-shaped cross-sectional shape, and is constructed by two inner surfaces M facing each other in such a manner that a width becomes narrower toward a deepest portion.

Further, a light source 31 constituted by an LED lamp (not shown) irradiating the light is arranged in a left end of the light guiding body 30. Further, to the light source 31, there is connected a harness 32 for supplying a necessary power source for the light source 31 to irradiate the light, and for connecting a control section (not shown) controlling the irradiation of the light. Further, the light is irradiated from the light source 31 toward a right end of the light guiding body 30 from a left end of the light guiding body 30, in accordance with an instruction of the control section.

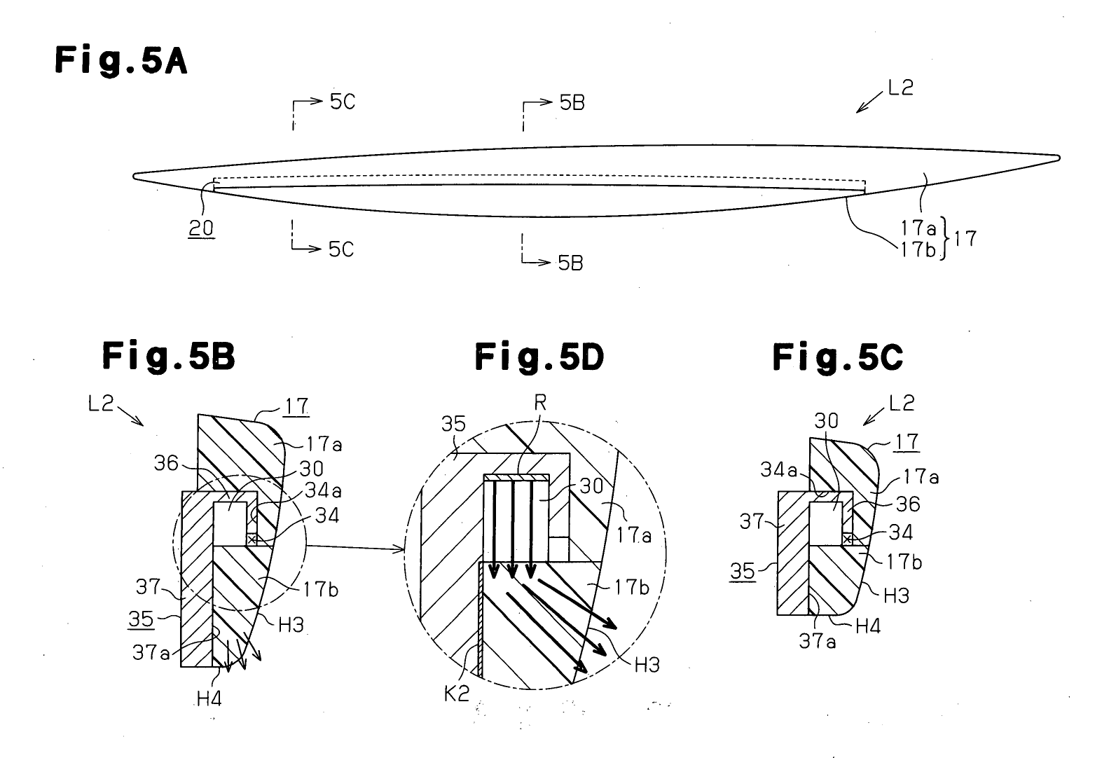

Light IL incident to the light guiding body 30 from the light source 31 is propagated within the light guiding body 30. At a time of the propagation, a part of the incident light IL is reflected toward the front surface 30a from an inner surface M of each of the slits, and the reflected light RL transmits through the front surface 30a so as to exit to the outside from the light guiding body 30. Further, the light transmitting through the rear surface 30b of the light guiding body 30 without being reflected by the inner surface M of each of the slits is again returned into the light guiding body 30 by a reflection plate R (refer to FIGS. 3D and 5D) arranged in the rear surface 30b of the light guiding body 30.

The reflection plate R is formed as a white sheet shape capable of reflecting or diffusing the light. Further, the reflection plate R is provided at a position supporting the light guiding body 30 in the support device main body 27. Further, the light returned into the light guiding body 30 transmits through the front surface 30a. Accordingly, it is possible to emit the light from an entire of the front surface 30a of the light guiding body 30.

As shown in FIGS. 3B and 3C, the light guiding body 30 is pinched by the support portion 26 and the inner surface 25a of the accommodation space 25 in a state of assembling the support device 21 in the accommodation space 25, and is supported and fixed. Further, in a state in which the support device 21 is assembled in the accommodation space 25, the support portion 26 and the inner surface 25a are brought into surface contact with each other, the notch portion 28 and the protrusion portion 23 are brought into surface contact with each other, and the extension portion 29 and the translucent portion 14b are brought into surface contact with each other, whereby the support device 21 is fixed. The support device 21 is inserted to the accommodation space 25 by being slid from any one of both ends thereof.

In a state in which the board lighting apparatus L1 is completed, as shown in FIG. 3D, a front surface 30a of the light guiding body 30, that is, a surface to which the incident light is emitted faces a back surface of the translucent portion 14b, that is, the inner surface 25a of the accommodation space 25. Further, the light emitted from the front surface 30a of the light guiding body 30 transmits through the translucent portion 14b, and is irradiated to the outside of the decoration member 14. In this case, in FIG. 3B, an arrow schematically shows a light path.

Further, in the state in which the board lighting apparatus L1 is completed, as shown in FIG. 3D, the decorative surface K1 of the support device 21 faces the back surface of the translucent portion 14b, that is, the inner surface 25a of the accommodation space 25. Further, in the case of viewing the decoration member 14 from the front surface, the inner portion of the accommodation space 25 is invisible via the translucent portion 14b, and the woodgrain decoration of the decoration portion 14a and the metallic decoration of the decorative surface K1 are visible.

Next, a description will be given of the console lighting apparatus L2. In this case, the description is given of the console lighting apparatus L2 arranged in the front passenger seat side, and since the console lighting apparatus L2 arranged in the driver seat side has the same structure as the console lighting apparatus L2 arranged in the front passenger seat side, a description thereof will be omitted.

As shown in FIGS. 5A, 5B, 5C and 5D, the decoration member 17 constructing the console lighting apparatus L2 is molded in an elongated arch shape. The front surface of the decoration member 17 is formed in such a diagonal shape that a thickness is reduced toward a lower side. The decoration member 17 is constituted, for example, by a decoration portion 17a to which a woodgrain pattern shown in an enlarged view in FIG. 1 is applied, and a translucent portion 17b to which the pattern is not applied, and which serves as a luminous portion capable of transmitting the light, and the decoration portion 17a and the translucent portion 17b are integrally molded. The pattern is applied to the decoration portion 17a in accordance with an in-mold process, a hydraulic pressure transfer process or the like. The pattern is applied to the decoration portion 17a in such a manner as to prevent the light from transmitting. The decoration portion 17a is provided in an upper side of the decoration member 17, and the translucent portion 17b is provided in the lower side of the decoration member 17.

A recessed accommodation space 34 open to a back surface of the decoration portion 17a is formed in the back surface. The accommodation space 34 accommodates the lighting member 20 for irradiating the light, and accommodates a support device 35 serving as a support member for supporting the lighting member 20. Since a structure of the lighting member 20 accommodated in the accommodation space 34 of the decoration member 17 is the same as the structure of the lighting member 20 accommodated in the accommodation space 25 of the decoration member 14, a description thereof will be omitted.

Further, the translucent portion 17b is continuously provided in a lower side of the decoration portion 17a, and is formed in such a trapezoidal cross-sectional shape as to have a inclined surface H3 of the decoration member 17, and a horizontal surface H4 continuously provided in the inclined surface H3. The inclined surface H3 and the horizontal surface H4 form a luminous surface irradiating the light into the passenger compartment. The inclined surface H3 of the decoration member 17 has a gentle inclination in comparison with the inclined surface H1 of the decoration member 14. Further, the light transmitting through the inclined surface H3 in the translucent portion 17b is irradiated toward a diagonally forward side from the decoration member 17 as shown in FIG. 5B. On the other hand, the light transmitting through the horizontal surface H4 is irradiated toward a lower side of the decoration member 17 as shown in FIG. 5B.

The support device 35 is made of a resin, and is provided with a support device main body 37 having a surface 37a aligning with the back surface of the translucent portion 17b. A hook-shaped support portion 36 supporting the lighting member 20 (the light guiding body 30) within the accommodation space 34 is formed in the support device main body 37. Further, a metallic lustrous shining decoration is applied to a portion corresponding to a front surface 37a of the support device main body 37, and facing the inner surface of the translucent portion 17b in a state in which the support device 35 is accommodated in the accommodation space 34. In the following description, the surface 37a of the support device main body 37 to which the decoration is applied is called as a decorative surface K2. The support device 35 has the same length as the accommodation space 34 formed in the decoration member 17, and extends over between both the right and left end portions of the decoration member 17.

As shown in FIGS. 5B and 5C, the light guiding body 30 is pinched between the support portion 36 and the inner surface 34a of the accommodation space 34 in a state in which the support device 35 is assembled in the accommodation space 34 so as to be fixed. Further, the support device 35 is fixed on the basis of the surface contact between the support portion 36 and the inner surface 34a in a state of being assembled in the accommodation space 34. The support device 35 is inserted to the accommodation space 34 by being slid from an opening in any one of both ends.

In a state in which the console lighting apparatus L2 is completed, as shown in FIG. 5D, the front surface 30a of the light guiding body 30 faces the back side of the translucent portion 17b, that is, the inner surface 34a of the accommodation space 34. Further, the light emitted from the front surface 30a of the light guiding body 30 transmits through the translucent portion 17b, and is irradiated to the outside of the decoration member 14. In FIGS. 5B and 5D, an arrow schematically shows a light path.

In a state in which the console lighting apparatus L2 is completed, as shown in FIG. 5D, the decorative surface K2 of the support device 35 faces the back side of the translucent portion 17b, that is, the inner surface 34a of the accommodation space 34. Further, in the case that the decoration member 17 is seen from the front surface, the state of the accommodation space 34 is not seen via the translucent portion 17b, and the woodgrain decoration of the decoration portion 17a and the metallic decoration of the decorative surface K2 can be seen.

Next, a description will be given of an operation in the case that the board lighting apparatus L1 and the console lighting apparatus L2 in accordance with the present embodiment are installed within the passenger compartment.

In the board lighting apparatus L1 and the console lighting apparatus L2 in accordance with the present embodiment, if the light source 31 is turned on, the light is irradiated from the translucent portions 14b and 17b. In this case, the light source 31 may be structured such as to be turned on in the case of operating a light switch instructing lighting of a head light or the like installed in the vehicle, or may be structured such as to be turned on in the case of operating a special switch provided independently from the light switch.

Further, in the case that the board lighting apparatus L1 is turned on, the glove compartment 13 is lighted from the above. The light irradiated from the board lighting apparatus L1 illuminates a portion around an upper edge 13d of the glove compartment 13 in the case that the glove compartment 13 is closed, whereby the light forms a light applying decoration so as to increase a decorative effect within the passenger compartment.

On the other hand, in the case that the glove compartment 13 is open, the light irradiated from the board lighting apparatus L1 illuminates the space 13a from the upper edge 13d side of the glove compartment 13, whereby the light forms the illumination light so as to obtain an illumination effect. In the present embodiment, the translucent portion 14b of the board lighting apparatus L1 serves as a luminous portion obtained by integrally forming the decoration luminous portion generating light for decoration, and the illuminating luminous portion generating light for the illumination.

Further, in the case that the console lighting apparatus L2 is turned on, one side of the center console 12 is illuminated. The light irradiated from the console lighting apparatus L2 illuminates the portion around the upper edge 12a of the center console 12, whereby the light forms the decorative light so as to increase the decorative effect within the passenger compartment. On the other hand, the light irradiated from the console lighting apparatus L2 illuminates the area around the feet of the passenger from the upper edge 12a side of the center console 12, whereby the light forms the illuminating light so as to cause the illumination effect, and improve a visibility around the feet. In the present embodiment, the translucent portion 17b of the console lighting apparatus L2 serves as a luminous portion obtained by integrally forming the decorative luminous portion generating light for decoration, and the illuminating luminous portion generating light for lighting.

Therefore, in accordance with the present embodiment, it is possible to obtain the following advantages.

(1) The translucent portion 14b of the decoration member 14 and the translucent portion 17b of the decoration member 17 are integrally formed for generating light for the purpose of both of decoration and lighting. Accordingly, it is possible to achieve the lighting apparatus (the board lighting apparatus L1 and the console lighting apparatus L2) combining the decorative function and the lighting function by a single apparatus. Therefore, it is possible to reduce a layout space of the lighting apparatus within the passenger compartment, and it is possible to easily arrange the wiring.

(2) The metallic decoration is applied to the decorative surfaces K1 and K2 facing the translucent portions 14b and 17b of the support devices 21 and 35. Accordingly, in the portion to which the decoration is applied, the back sides of the translucent portions 14b and 17b can be set to be invisible from the inner side of the passenger compartment. Therefore, it is possible to increase the decoration effect within the passenger compartment. Further, in the case that the light is irradiated, it is possible to further improve the lighting effect and the decoration effect, by reflecting the light to the decorative surfaces K1 and K2.

(3) The decoration portions 14a and 17a which do not transmit light, and the translucent portions 14b and 17b which transmit light are formed in the decoration members 14 and 17 of the board lighting apparatus L1 and the console lighting apparatus L2. Accordingly, the decoration effect provided in the decoration portions 14a and 17a can be different from the decoration effect provided in the translucent portions 14b and 17b. In other words, even in the case that light is not irradiated, the board lighting apparatus L1 and the console lighting apparatus L2 can have the decoration effect by the decoration portions 14a and 17a. Further, in the case of irradiating the light, the board lighting apparatus L1 and the console lighting apparatus L2 can increase the decoration effect on the basis of the decoration of the decoration portions 14a and 17a, and the light irradiated from the translucent portions 14b and 17b.

(4) Light is irradiated from the front surface 30a of the light guiding body 30 by emitting the light from the LED lamp of the light source 31 into the light guiding body 30, and reflecting the incident light on the inner surface M of the slit S. Accordingly, the translucent portions 14b and 17b execute a surface emission. Therefore, it is possible to irradiate light from the entire translucent portions 14b and 17b of the decoration members 14 and 17 without setting a plurality of LED (or lamps) within the translucent portions 14b and 17b, thereby contributing to a cost reduction.

(5) The decoration members 14 and 17 are molded from resin. Accordingly, the molding and machining for decoration are facilitated. Further, the light guiding body 30 of the lighting member 20 is also molded from resin. Accordingly, it is easy to mold the light guiding body 30 and it is easy to execute such a work as a modifying work of the board lighting apparatus L1 and the console lighting apparatus L2 in correspondence to an applied place. In other words, it is possible to apply the board lighting apparatus L1 and the console lighting apparatus L2 regardless of the place and the type of vehicle.

(6) The board lighting apparatus L1 and the console lighting apparatus L2 are arranged in the upper edge 13d of the glove compartment 13 and the upper edge 12a of the center console 12. Accordingly, the board lighting apparatus L1 decorates the portion around the glove compartment 13, and illuminates the portion within the space 13a of the glove compartment 13. Further, the console lighting apparatus L2 decorates the portion around the center console 12, and illuminates the portion around the feet of the passenger. Accordingly, it is possible to make the passenger recognize the light irradiated from the board lighting apparatus L1 as the light for decoration in the case that the glove compartment 13 is not open, and it is possible to make the passenger recognize the light irradiated from the board lighting apparatus L1 as the light for lighting in the case that the glove compartment 13 is open. Further, it is possible to make the passenger recognize the light irradiated from the console lighting apparatus L2 as the light for decoration in the case that the passenger sits on the seats 18 and 19, and it is possible to make the passenger recognize the light irradiated from the console lighting apparatus L2 as the light for lighting the portion around the feet in the case that the passenger gets on and off the vehicle.

The above embodiment may be modified as follows.

The decoration portions 14a and 17a of the decoration members 14 and 17 may be structured such as to transmit the light. In other words, the structure may be made such that light transmits through the entire decoration members 14 and 17.

The structure may be made such that the front surface 30a of the light guiding body 30 is directed to the support devices 21 and 35, and the rear surface 30b faces the back surfaces of the translucent portions 14b and 17b, whereby light reflected by the inner surface M of the slit S is reflected by the reflection plate R. Further, the structure may be made such that the reflected light reflected by the reflection plate R is again irradiated from the translucent portions 14b and 17b through the inner side of the light guiding body 30.

The board lighting apparatus L1 and the console lighting apparatus L2 may be embodied as the lighting apparatus installed in other positions. For example, it may be embodied as the lighting apparatus installed in a door of the vehicle. In the case that it is embodied as a lighting apparatus for a door, it is possible to decorate the portion around the door, and it is possible to illuminate the lock apparatus of the door or the like, whereby it is possible to provide both of the decorating function and the lighting function in the same manner as the board lighting apparatus L1 and the console lighting apparatus L2 in the embodiment.

Further, it may be embodied as a lighting apparatus for rear seats in a vehicle. In the case of being embodied as a lighting apparatus for rear seats, it is possible to decorate the portion around the rear seats and it is possible to illuminate the portion around the feet and near the hands of a passenger in the rear seats, by installing the apparatus in a rear surface of a backrest portion of the front seat.

The structure may be made such that the decorative surfaces K1 and K2 of the support devices 21 and 35 are applied to the support portions 26 and 36, and the metallic decoration may serve as a substitute for the reflection plate R, thereby reflecting the incident light transmitting through the slit S.

A plurality of LED lamps may be arranged linearly in place of the light guiding body 30.

The metallic decoration applied to the support devices 21 and 35 may be omitted.

The reflection plate R may be omitted.

1. A lighting apparatus for a vehicle, the apparatus having a luminous portion irradiating light generated from a luminous body into a passenger compartment,
wherein said luminous portion is structured by integrally forming a decorating portion generating light for decorating an inner side of said passenger compartment, and a lighting portion generating light for lighting a predetermined position within the passenger compartment.

2. The lighting apparatus for a vehicle according to claim 1, wherein said luminous body is provided with a translucent light guiding body,
wherein said lighting apparatus is provided with a support member in which a support portion supporting said light guiding body is formed,
wherein said light guiding body is attached to a back surface of said luminous portion by said support member, and
wherein a decoration is applied to a position facing the luminous portion in the support member.

3. The lighting apparatus for a vehicle according to claim 1, wherein said luminous portion is continuously provided with a decoration portion to which decoration is applied in such a manner as to prevent the light generated from said luminous body from transmitting.

4. The lighting apparatus for a vehicle according to claim 1, wherein said lighting apparatus is provided around a glove compartment within the passenger compartment, or around a center console,
wherein said luminous portion provided around said glove compartment decorates a portion around said glove compartment, and lights a storage space of said glove compartment at a time when said glove compartment is open, and
wherein said luminous portion provided around said center console applies a decoration to a portion around said center console, and lights an area around the feet of a passenger.

5. The lighting apparatus for a vehicle according to claim 2, comprising a light source,
wherein a plurality of slits for reflecting light emitted by said light source are formed in said light guiding body, and
wherein the light emitted to said light guiding body from said light source is irradiated into said passenger compartment via said luminous portion by being reflected by said slit, or is irradiated into said passenger compartment via said luminous portion by being reflected by said slits and being thereafter again reflected by said support member.
